(19) United States
(12) Patent Application Publication
(10) Pub. No.: US 2026/0225200 A1
(43) Pub. Date: Aug. 6, 2026

(54) MACHINE TOOL ASSEMBLY WITH TOOL BASE AND LATCHABLE WORKPIECE FRAME

(71) Applicant: Rolls-Royce Corporation, Indianapolis, IN (US)

(72) Inventor: Rusty Garner, Indianapolis, IN (US)

(21) Appl. No.: 19/046,904

(22) Filed: Feb. 6, 2025

(51) Int. Cl. B23Q 7/04; B23Q 1/52

(52) U.S. Cl. CPC B23Q 7/047; B23Q 1/52; B23Q 7/046

(57) ABSTRACT

A machine tool system includes a workpiece, a machine configured to modify the workpiece, and a workpiece frame. The workpiece frame is repositionable and relocatable on the machine in at least two different orientations to support the workpiece in the at least two different orientations during modification of the workpiece. As a result, different sides of the workpiece are modified without requiring removal of the workpiece from the workpiece frame.

### FIELD OF THE DISCLOSURE

The present disclosure relates generally to machine tool systems, and more specifically to workpiece frames of machine tool systems.

### BACKGROUND

Electrochemical machining (ECM) is a non-contact, non-thermal material removal process capable of small features, high quality surfaces, and high repeatability for production parts. Pulsed electrochemical machining (PECM), sometimes called precision electrochemical machining, is a more precise variant of ECM that uses a pulsed power supply.

Unlike many other manufacturing processes, there is no contact between the machining component or tool bit, which may be referred to as a cathode, and the workpiece in PECM. Material of the workpiece in close proximity to the machining component is dissolved by an electrochemical process, and the by-products are flushed away with a flowing electrolyte. The resulting workpiece has the shape that is an inverse of the machining component.

PECM provides some advantages over other manufacturing processes. For example, PECM may be used for relatively hard materials that may be difficult to machine using conventional methods. As another example, PECM can be used to machine small, intricate, or complex shapes or contours with a relatively high surface quality. Some workpieces may be easily distorted or non-repositionable and, thus, difficult to reposition during PECM.

### SUMMARY

The present disclosure may comprise one or more of the following features and combinations thereof.

According to an aspect of the present disclosure, a machine tool system includes a three-dimensional workpiece, a machine configured to modify the three-dimensional workpiece, and a workpiece frame. The machine includes a tool configured to interface with the three-dimensional workpiece and a shaft spaced apart from the tool along a first axis and configured to move along the first axis relative to the tool to modify the three-dimensional workpiece. The workpiece frame is repositionable and relocatable on the tool in at least two different orientations to support the three-dimensional workpiece in the at least two different orientations relative to the first axis during modification of the three-dimensional workpiece so that different sides of the three-dimensional workpiece are modified without requiring removal of the three-dimensional workpiece from the workpiece frame.

The workpiece frame includes a body and a workpiece locator. The body defines a workpiece-receiving space therein and is removably coupled with the workpiece. The workpiece locator includes a first pin coupled with and extending away from the body. The tool includes a fixture having a fixture body and a first latch clamp coupled with the fixture body and selectively engaged with the first pin of the workpiece frame to urge the workpiece frame toward the fixture and removably couple the workpiece frame with the tool.

In some embodiments, the fixture includes fluid passages formed therein and configured to direct a fluid onto the workpiece during operation of the machine. The workpiece frame is repositionable and relocatable on the fixture in the at least two different orientations.

In some embodiments, the tool further includes a base fixture coupled with a frame of the machine to locate the workpiece relative to the shaft. The workpiece frame is repositionable and relocatable on the base fixture in the at least two different orientations.

In some embodiments, the fixture is coupled with a frame of the machine to locate the workpiece relative to the shaft. The workpiece frame is repositionable and relocatable on the fixture in the at least two different orientations.

In some embodiments, the workpiece frame further includes a second pin spaced apart from the first pin. The first latch clamp is selectively engaged with the first pin and the second pin to couple the workpiece frame to the fixture.

In some embodiments, the workpiece frame further includes a second pin spaced apart from the first pin. The tool includes a second latch clamp that is selectively engaged with the second pin to couple the workpiece frame to the fixture. In some embodiments, the second pin extends parallel to the first pin.

In some embodiments, the workpiece frame further includes a second pin that is spaced apart from the first pin and extends into the fixture to limit movement of the workpiece relative to the fixture. In some embodiments, the first pin is formed with a groove that receives a portion of the latch clamp therein.

In some embodiments, the latch clamp includes a latch engaged with the first pin and a handle coupled with the latch and configured to rotate about a handle axis to open and close the latch. The latch includes a first arm, a second arm spaced apart from the first arm, and a bar that extends between the first arm and the second arm, and the first pin is formed with a groove that receives a portion of the bar.

According to another aspect of the present disclosure, a machine tool system includes a workpiece, a machine configured to modify the workpiece, and a workpiece frame. The workpiece frame is repositionable and relocatable on the machine in at least two different orientations to support the workpiece in the at least two different orientations during modification of the workpiece so that different sides of the workpiece are modified without requiring removal of the workpiece from the workpiece frame. The workpiece frame includes a body that is removably coupled with the workpiece and a workpiece locator that includes a first pin coupled with and extending away from the body.

In some embodiments, the machine includes a tool for interfacing with the workpiece frame. The tool includes a fixture having a fixture body and a latch clamp coupled with the fixture body and selectively engaged with the first pin to removably couple the workpiece frame with the tool.

In some embodiments, the fixture is coupled with a frame of the machine. The workpiece frame is repositionable and relocatable on the fixture in the at least two different orientations without separating the workpiece from the workpiece frame.

In some embodiments, the fixture includes fluid passages formed therein and configured to direct a fluid onto the workpiece during operation of the machine. The workpiece frame is repositionable and relocatable on the fixture in the at least two different orientations without separating the workpiece from the workpiece frame.

In some embodiments, the workpiece frame further includes a second pin spaced apart from the first pin. The first latch clamp is selectively engaged with both the first pin and the second pin to couple the workpiece frame to the fixture. In some embodiments, the first pin is formed with a groove that receives a portion of the latch clamp therein.

In some embodiments, the latch clamp includes a latch engaged with a groove of the first pin and a handle coupled with the latch and configured to rotate about a handle axis to open and close the latch. In some embodiments, the handle rotates less than 360 degrees to move the latch clamp from a fully open position to a fully closed position.

In some embodiments, the latch includes a first arm, a second arm spaced apart from the first arm, and a bar that extends between the first arm and the second arm. The first pin is formed with a groove that receives a portion of the bar.

According to another aspect of the present disclosure, a method of using a machine tool system is provided. The method includes coupling a workpiece to a workpiece frame; positioning the workpiece frame relative to a first fixture such that the workpiece is in a first orientation; latching the workpiece frame with the first fixture to couple the workpiece frame with the first fixture such that the workpiece is in the first orientation; applying a first machine operation to the workpiece; unlatching the workpiece frame from the first fixture; positioning the workpiece frame relative to a second fixture such that the workpiece is in a second orientation without separating the workpiece from the workpiece frame; latching the workpiece frame with the second fixture to couple the workpiece frame with the second fixture such that the workpiece is in the second orientation; and applying a second machine operation to the workpiece.

In some embodiments, the method includes latching the workpiece frame with the first fixture to couple the workpiece frame with the first fixture such that the workpiece is in the first orientation includes closing a latch clamp around at least one pin coupled with a body of the workpiece frame.

These and other features of the present disclosure will become more apparent from the following description of the illustrative embodiments.

### BRIEF DESCRIPTION OF THE DRAWINGS

FIG. 1 is a diagrammatic view of a machine tool system including a workpiece frame removably coupled to a base fixture of a tool of a machine in a first position, the workpiece frame supports a workpiece thereon in a first orientation relative to a shaft of the machine that modifies a first side of the workpiece by moving along a first axis;

FIG. 2 is a diagrammatic view of the machine tool system of FIG. 1 showing the workpiece frame removably coupled to the tool of the machine in a second position, the workpiece frame supports the workpiece thereon in a second orientation relative to the shaft of the machine that modifies the workpiece by moving along the first axis, the workpiece frame allowing for movement of the workpiece between the first and second orientations without requiring removal of the workpiece from the workpiece frame;

FIG. 3 is a perspective view of a portion of the machine tool system of FIG. 1 showing the workpiece located in the workpiece frame;

FIG. 4 is an exploded view of a portion of the machine tool system of FIG. 3 showing the workpiece and the workpiece frame;

FIG. 5 is a back elevation view of the workpiece and the workpiece frame of the machine tool system of FIG. 1;

FIG. 6 is a front elevation view of the workpiece and the workpiece frame of the machine tool system of FIG. 1;

FIG. 7 is an exploded view of the workpiece coupled with the workpiece frame, the base fixture of the tool, and an accessory fixture adapted to provide fluid to the workpiece during machining of the workpiece;

FIG. 8 is an exploded view similar to FIG. 7 with the workpiece frame latched to the accessory fixture in a first orientation and suggesting the workpiece frame is adapted to couple with the base fixture;

FIG. 9 is a perspective view of the machine tool system with the workpiece frame coupled with the accessory fixture and the base fixture in a first orientation and suggesting that the workpiece is located to be worked upon by the machine;

FIG. 10 is a section view of the machine tool system showing the workpiece frame coupled with the base fixture and latched with the accessory fixture;

FIG. 11 is an exploded view of the workpiece coupled with the workpiece frame and a second accessory fixture and suggesting that the workpiece and workpiece frame are adapted to latch to the second accessory fixture in a second orientation so another side of the workpiece may be worked on by the machine;

FIG. 12 is a perspective view of the machine tool system with the workpiece frame coupled with the second accessory fixture and the base fixture in the second orientation and suggesting that the workpiece is located to be worked upon by the machine;

FIG. 13 is an exploded view of the workpiece coupled with the workpiece frame and another embodiment of a base fixture and suggesting that the workpiece frame is configured to latch to the base fixture in multiple orientations; and

FIG. 14 is a perspective view of the machine tool system of FIG. 12 showing the workpiece coupled with the workpiece frame and the workpiece frame latched to the base fixture such that the machine may work on the workpiece in a first orientation.

### DETAILED DESCRIPTION

For the purposes of promoting an understanding of the principles of the disclosure, reference will now be made to a number of illustrative embodiments illustrated in the drawings and specific language will be used to describe the same.

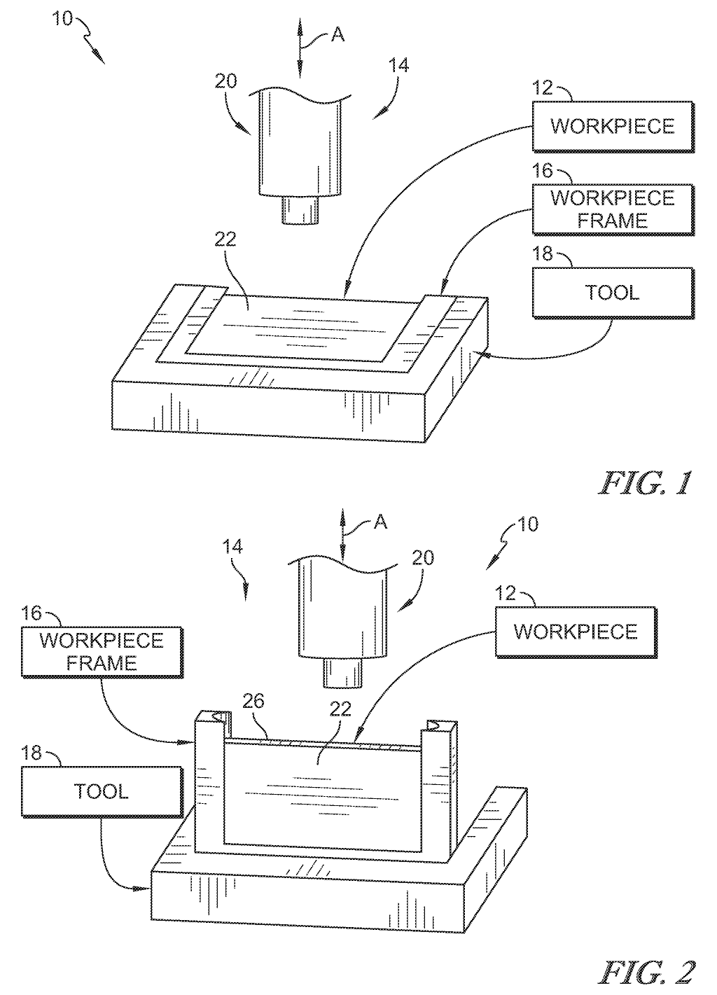

A machine tool system 10 includes a workpiece 12, a machine 14, and a workpiece frame 16, as shown in FIGS. 1 and 2. In illustrative embodiments, the workpiece 12 is a thin-walled three-dimensional workpiece. The machine 14 is configured to modify the workpiece 12. The workpiece frame 16 supports the workpiece 12 and is repositionable and relocatable on the machine 14 in different positions. The workpiece 12 remains stationary relative to the workpiece frame 16 such that repositioning of the workpiece frame 16 on the machine 14 also repositions the workpiece 12 such that different sides of the workpiece 12 may be modified by the machine 14 without requiring removal of the workpiece 12 from the workpiece frame 16.

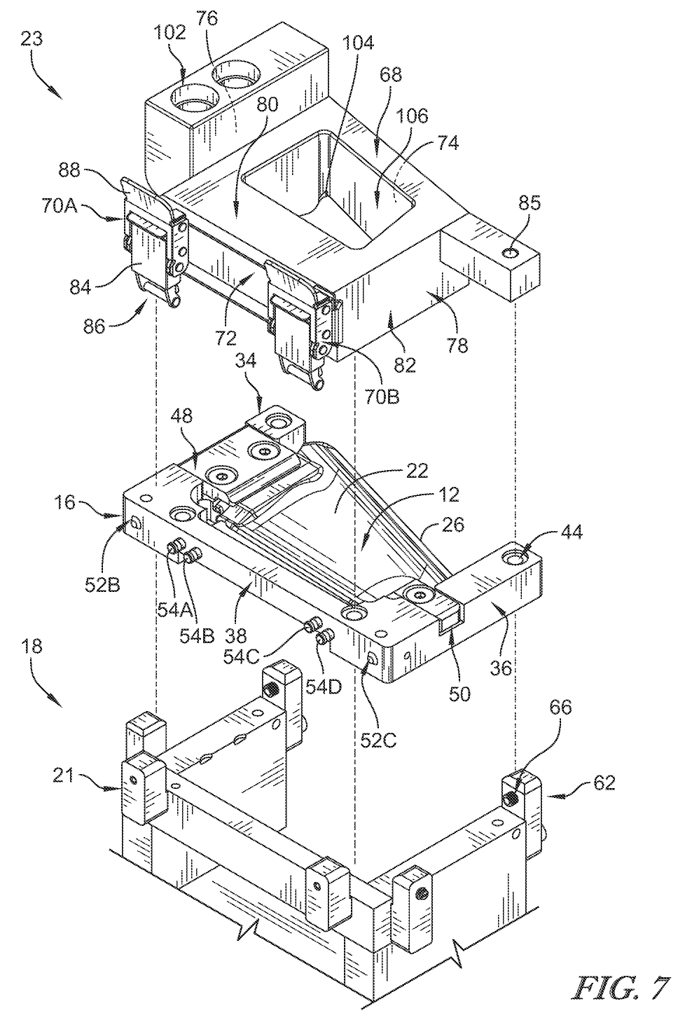

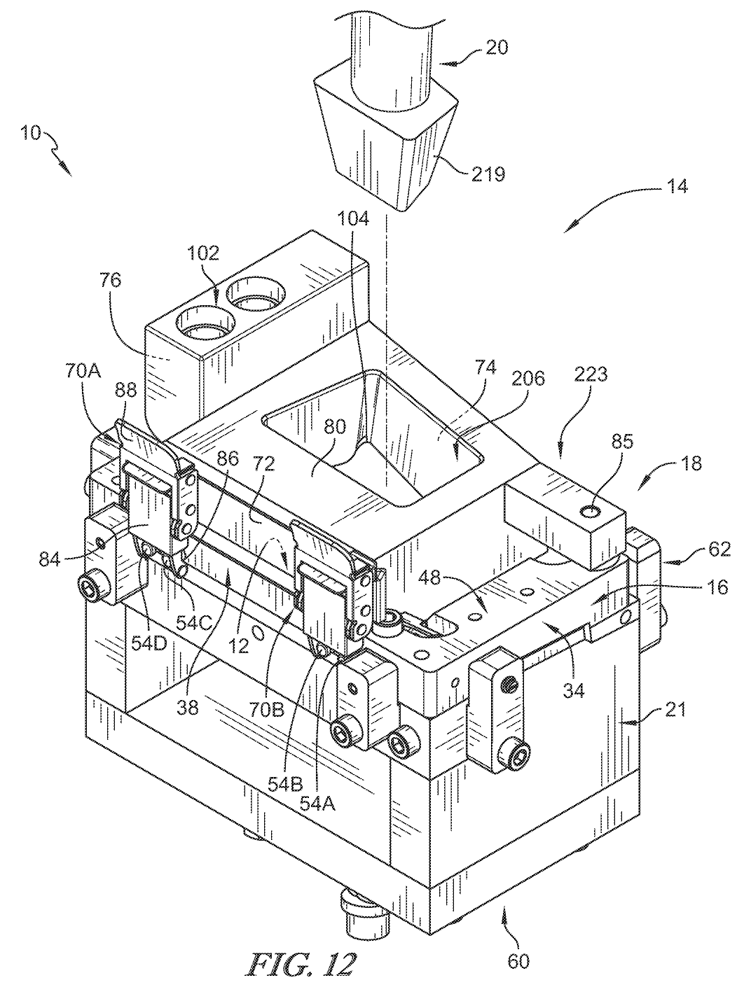

The machine 14 includes a tool 18 and a shaft 20, as shown in FIGS. 1 and 2. The tool 18 supports the workpiece frame 16, and thus, the workpiece 12, relative to the shaft 20. The shaft 20 is spaced apart from the tool 18 and moves along a first axis A to modify the workpiece 12. The tool 18 includes a base fixture 21 for fixing the workpiece frame 16 to the machine 14 as shown in FIGS. 1 and 2. The tool 18 may further include accessory fixtures 23 such as the accessory fixture 23 shown in FIGS. 7-10 and the accessory fixture 223 shown in FIGS. 11 and 12.

The workpiece frame 16 is configured to removably couple with the base fixture 21 and is movable between at least a first orientation, as shown in FIG. 1, and a second orientation, shown in FIG. 2. In the illustrative embodiment shown in FIGS. 1 and 2, the second orientation is offset by about 90 degrees compared to the first orientation. In other embodiments, the second orientation is offset by 180 degrees compared to the first orientation as shown in FIGS. 7-11. In other embodiments, the second orientation may be offset from the first orientation by any suitable rotation angle and about any suitable axis through the workpiece frame 16.

In some embodiments, the machine 14 is capable of pulsed electrochemical machining (PECM). In such an embodiment, the shaft 20 or bit attached to the shaft 20 may be referred to as a cathode. To modify the workpiece 12, the shaft 20 moves toward the workpiece 12 and oscillates along the first axis A, but does not contact the workpiece 12. Once the shaft 20 is adjacent the workpiece 12 to form a gap therebetween, an electrolyte is injected into the gap. The electrolyte acts as an electron transfer medium to facilitate anodic dissolution of the material of the workpiece 12 adjacent the shaft 20. In some embodiments, the electrolyte may be a salt-based solution. The electrolyte allows electrical current to flow between the shaft 20 and the workpiece 12. Any by-products, such as, for example, metal hydroxides or hydrogen gas, of the electrochemical process are then flushed away by the electrolyte. The shaft 20 illustratively has a shape inverse to that of the desired workpiece 12 shape. In some embodiments, the shaft 20 may comprise titanium, stainless steel, copper, or any other suitable current carrying material.

Because PECM is a non-contact and non-thermal process, the workpiece 12 is not subjected to thermal or mechanical stresses. Additionally, because PECM is a non-contact and non-thermal process, the shaft 20 is not typically consumed or worn during the process of machining. In other embodiments, the machine 14 performs other subtractive or additive processes and may contact the workpiece 12. For example, the machine 14 may provide turning, milling, drilling, grinding, cutting, laser cutting, waterjet cutting, electrical discharge machining, plasma cutting, laser deposition, 3D printing, etc.

In some embodiments, the machine 14 is a single axis machine 14. In other words, the shaft 20 of the machine 14 only moves along the first axis A. Thus, to modify different sides of the workpiece 12, the workpiece 12 is repositioned such that the different sides may be modified by the shaft 20 moving along the first axis A. However, the workpiece 12 may be relatively thin and easily distorted or non-repositionable in conventional fixtures and any repositioning of the workpiece 12 itself may distort the workpiece 12. The workpiece frame 16 and tool 18 of the present disclosure provides the ability to reposition the workpiece 12 without removal of the workpiece 12 from the workpiece frame 16. In this way, the workpiece frame 16 is repositioned, which also repositions the workpiece 12, while allowing the workpiece 12 to remain stationary relative to the workpiece frame 16.

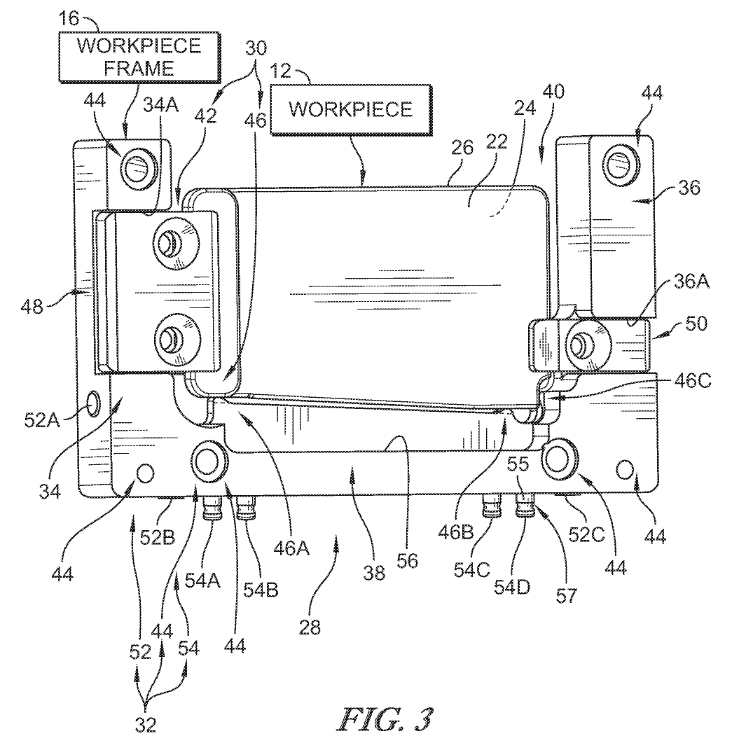

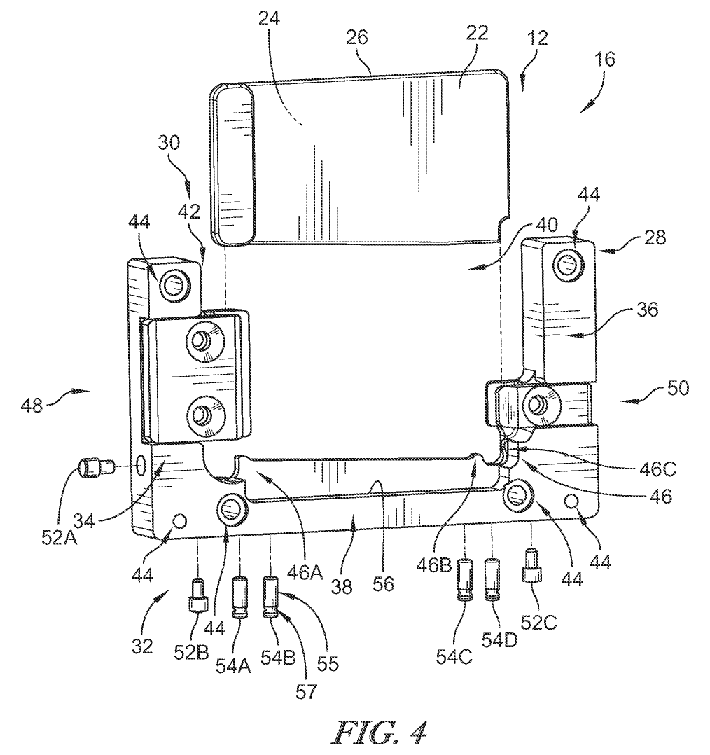

The workpiece 12 is illustratively a thin-walled three-dimensional workpiece, as shown in FIGS. 3 and 4. The workpiece 12 includes a first side 22, a second side 24 opposite the first side 22, and an edge 26 that extends between and interconnects the first side 22 and the second side 24. The first side 22, the second side 24, and the edge 26 may each be modified by the machine 14 by repositioning the workpiece frame 16. In some embodiments, the workpiece 12 may be used in a gas turbine engine. For example, the workpiece 12 may form a part of a vane or a blade of a gas turbine engine. The workpiece 12 may provide a coversheet for a pressure side and/or a suction side of a vane or blade.

As shown in FIGS. 1 and 2, the workpiece frame 16 is repositionable and relocatable on the tool 18 in different positions to support the workpiece 12 in different orientations relative to the first axis A during modification of the workpiece 12 so that different sides of the workpiece 12 are modified without requiring removal of the workpiece 12 from the workpiece frame 16. As shown in FIG. 1, the workpiece frame 16 is in a first position relative to the base fixture 21 of the tool 18 and the shaft 20. While the workpiece frame 16 is in the first position, the workpiece 12 is in a first orientation relative to the first axis A. In the first orientation of the workpiece 12, the first side 22 of the workpiece 12 is modified. The first orientation of the workpiece 12 may be an orientation with the first side 22 facing upwardly toward the shaft 20.

As shown in FIG. 2, the workpiece frame 16 is in a second position relative to the base fixture 21 and the shaft 20. While the workpiece frame 16 is in the second position, the workpiece 12 is in a second orientation relative to the first axis A. In the second orientation of the workpiece 12, the edge 26 of the workpiece 12 is modified. The second orientation of the workpiece 12 may be an orientation with the edge 26 facing upwardly toward the shaft 20.

Though two different positions of the workpiece frame 16 and two different orientations of the workpiece 12 are shown, it will be understood that additional positions and orientations may be used. For example, the workpiece frame 16 may be moved to a third position relative to the base fixture 21 and the shaft 20. While the workpiece frame 16 is in the third position, the workpiece 12 is in a third orientation relative to the first axis A. In the third orientation of the workpiece 12, the second side 24 of the workpiece 12 is modified as an example. The third orientation of the workpiece 12 may be an orientation with the second side 24 facing upwardly toward the shaft 20. In other words, the third position may be a flipped position of the first position. To move the workpiece frame 16 between each position, the workpiece frame 16 may be removed from the base fixture 21 and reattached to the base fixture 21 in a different position.

The workpiece frame 16 includes a body 28, a workpiece locator 30, and a frame locator 32, as shown in FIGS. 3 and 4. The body 28 is configured to be coupled to the base fixture 21 in the different positions. The workpiece locator 30 contacts the workpiece 12 to position the workpiece 12 relative to the body 28. The frame locator 32 contacts the base fixture 21 to position the body 28 relative to the base fixture 21. Precise positioning of the workpiece 12 relative to the body 28 and the body 28 relative to the base fixture 21 ensures that the workpiece 12 is properly aligned with the shaft 20 in the different orientations of the workpiece 12.

In illustrative embodiments, the body 28 is C-shaped, as shown in FIG. 3. The C-shaped body 28 provides open access to the edge 26 of the workpiece 12, as shown in FIGS. 2 and 3. This open access allows the machine 14 to more readily modify the workpiece 12. The C-shaped body 28, thus, provides access to three sides of the workpiece 12, including the first side 22, the second side 24, and the edge 26. In some embodiments, the body 28 may not be C-shaped.

The body 28 includes a first arm 34, a second arm 36, and a third arm 38. The first arm 34 and the second arm 36 are spaced apart from one another, and the third arm 38 extends between and interconnects first terminal ends of the first arm 34 and the second arm 36. Because the body 28 is C-shaped, second terminal ends of the first arm 34 and the second arm 36 are not interconnected, as shown in FIG. 3. The first arm 34, the second arm 36, and the third arm 38 cooperate to define a workpiece-receiving space 40. The first arm 34, the second arm 36, the third arm 38.

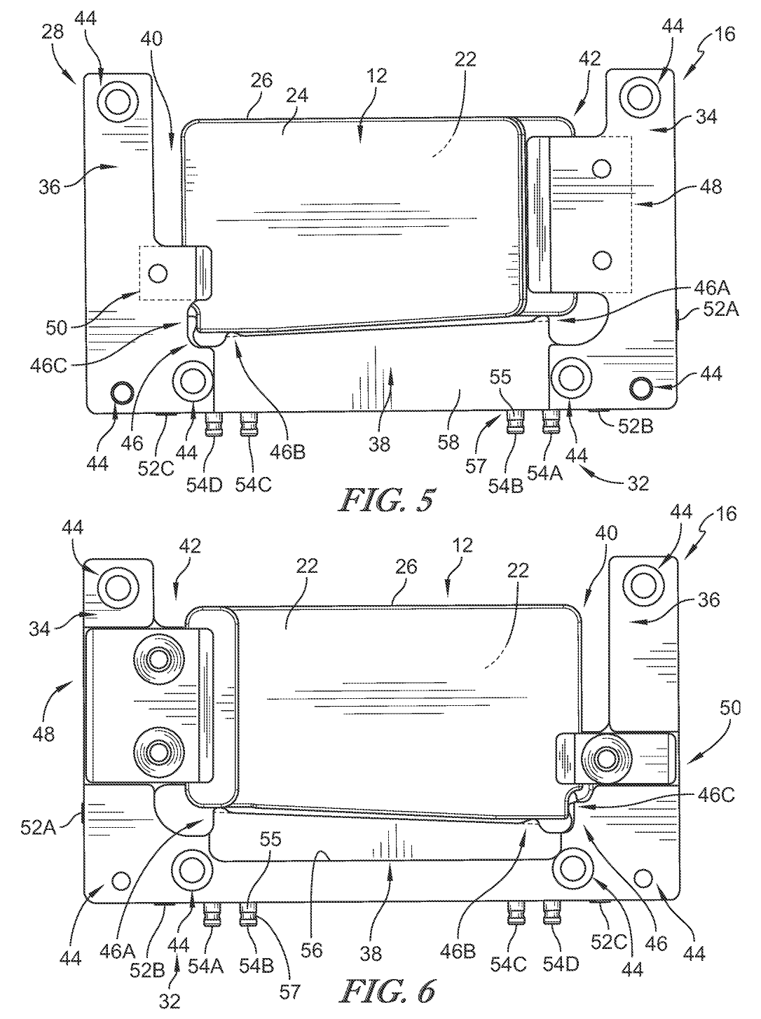

Illustratively, the arms 34, 36, 38 each define planar surfaces, as shown in FIGS. 5 and 6. For example, a front surface of each arm 34, 36, 38, as shown in FIG. 6, is substantially planar. As another example, a back surface of each arm 34, 36, 38, as shown in FIG. 5, is substantially planar. As another example, an outwardly-facing side surface of each arm 34, 36, 38, as shown in FIG. 3, is substantially planar. The substantially planar side surfaces act as primary datums for positioning the workpiece frame 16 in the base fixture 21. The primary datums ensure proper alignment of the body 28 with the base fixture 21.

The workpiece locator 30 includes a clamp 42 and a plurality of workpiece locating protrusions 46, as shown in FIGS. 3 and 4. The clamp 42 is coupled to the body 28 and extends into the workpiece-receiving space 40 to couple with the workpiece 12. The plurality of workpiece locating protrusions 46 extends into the workpiece-receiving space 40 from the body 28 to contact and locate the workpiece 12.

The clamp 42 illustratively includes a first clamp member 48 and a second clamp member 50 spaced apart from the first clamp member 48, as shown in FIGS. 3-6. The first clamp member 48 extends inwardly from the first arm 34 of the body 28 toward the second arm 36. The second clamp member 50 extends inwardly from the second arm 36 of the body 28 toward the first arm 34 and the first clamp member 48, as shown in FIG. 3. The first clamp member 48 and the second clamp member 50 support opposing ends of the workpiece 12 to hold the workpiece 12 in a stationary position relative to the body 28, as suggested in FIGS. 5 and 6.

The plurality of workpiece locating protrusions 46 extends into the workpiece-receiving space 40 from the body 28 to contact the workpiece 12 and to locate the workpiece 12 within the workpiece-receiving space relative 40 to the body 28, as shown in FIGS. 5 and 6. The plurality of workpiece locating protrusions 46 illustratively includes a first protrusion 46A, a second protrusion 46B, and a third protrusion 46C. The first protrusion 46A extends from the third arm 38 of the body 28 into the workpiece-receiving space 40. The second protrusion 46B extends from the third arm 38 of the body 28 into the workpiece-receiving space 40 and is spaced apart from the first protrusion 46A along the third arm 38. The third protrusion 46C extends from the second arm 36 of the body 28 into the workpiece-receiving space 40.

The frame locator 32 is located outside of the workpiece-receiving space 40 of the body 28, as shown in FIGS. 3 and 4. The frame locator 32 ensures that the body 28 is properly positioned on the tool 18, thereby ensuring that the workpiece 12 is properly positioned relative to the tool 18 and the shaft 20.

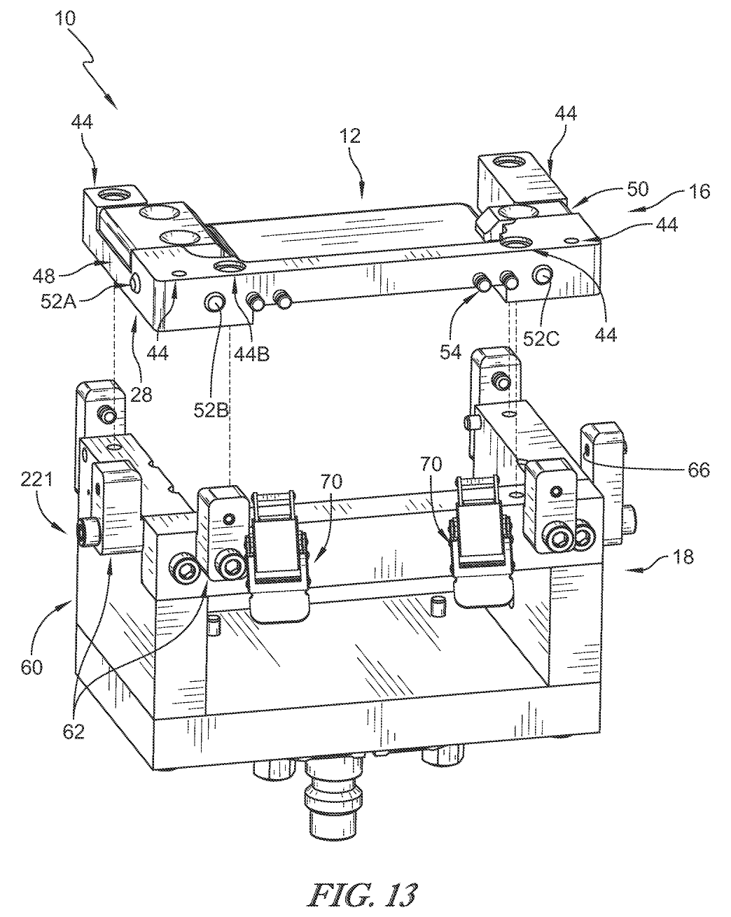

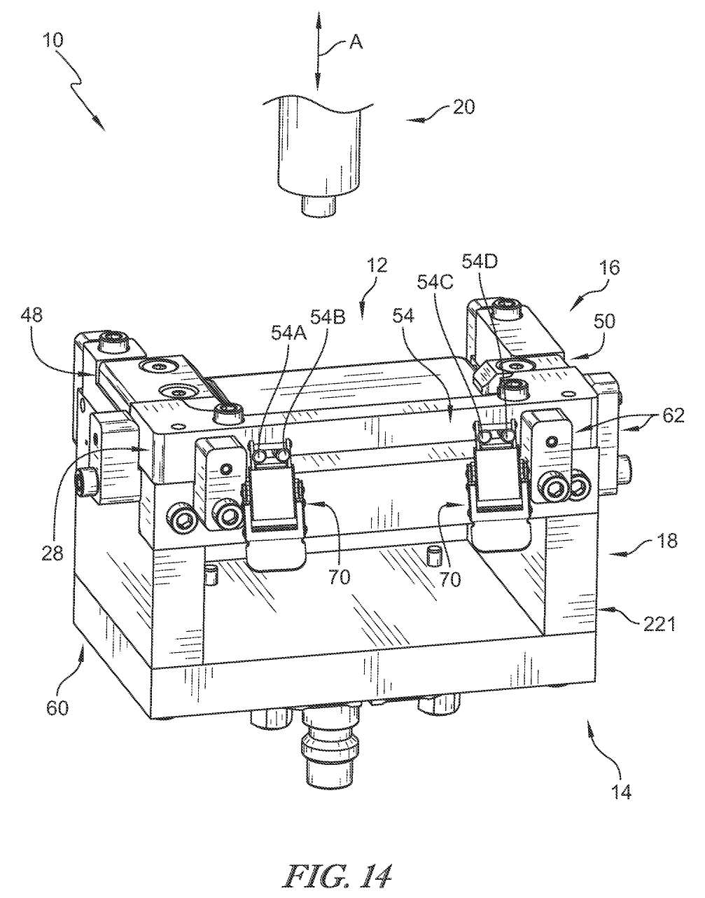

The frame locator 32 includes a plurality of fastener holes 44, a plurality of frame locating datums 52, and a plurality of pins 54, as shown in FIG. 4. The plurality of fastener holes 44 is used to couple the body 28 to the base fixture 21. The plurality of frame locating datums 52 is used to position the body 28 relative to the base fixture 21. The plurality of pins 54 is configured to couple an accessory fixture 23, 223 of the machine 14 to the workpiece frame 16 as shown in FIGS. 7-11 or to another embodiment of a base fixture 21 as shown in FIGS. 13 and 14. In the illustrative embodiment, the accessory fixture 23 includes a flow block that couples with the workpiece frame 16 to direct the electrolyte through the gap formed between the workpiece 12 and the shaft 20. Multiple accessory fixtures, such as accessory fixture 23 and accessory fixture 223 or any other suitable accessory fixtures, may be used during the machining process.

The plurality of frame locating datums 52 may be referred to as secondary and tertiary datums 52. The secondary and tertiary datums 52 illustratively include a first datum 52A, a second datum 52B, and a third datum 52C, as shown in FIG. 4. Though shown with three secondary and tertiary datums 52A, 52B, 52C, additional datums or fewer datums are contemplated. The first datum 52A, which may be referred to as the tertiary datum 52A, is coupled to the first arm 34 of the body 28 to extend outwardly away from the first arm 34 and the workpiece-receiving space 40. The first datum 52A extends outwardly from the first arm 34 beyond a surface of the first arm 34 that faces away from the workpiece-receiving space 40. The second datum 52B, which may be referred to as the secondary datum 52B, is coupled to the third arm 38 of the body 28 to extend outwardly away from the third arm 38 and the workpiece-receiving space 40. The second datum 52B extends outwardly from the third arm 38 beyond a surface of the third arm 38 that faces away from the workpiece-receiving space 40. The third datum 52C, which may be referred to as the secondary datum 52C, is coupled to the third arm 38 of the body 28 and spaced apart from the second datum 52B along the third arm 38. The third datum 52C extends outwardly away from the third arm 38 beyond the surface of the third arm 38 that faces away from the workpiece-receiving space 40.

Illustratively, each of the secondary and tertiary datums 52A, 52B, 52C is received in a corresponding hole formed in the body 28, as shown in FIG. 4. Each datum 52A, 52B, 52C is received in the corresponding hole to extend outwardly beyond the corresponding surface of the corresponding arm 34, 38. The secondary and tertiary datums 52A, 52B, 52C cooperate with the primary datums (the substantially planar surfaces of the arms 34, 36, 38) to help ensure proper alignment of the body 28 with the base fixture 21. After the body 28 is aligned with the base fixture 21 via the primary datums and the secondary/tertiary datums 52A, 52B, 52C, the fasteners may be inserted into the plurality of holes 44 to secure the workpiece frame 16 to the base fixture 21.

The plurality of pins 54 is coupled to and extends outwardly away from the third arm 38 of the body 28, as shown in FIGS. 3, 5, and 6. The plurality of pins 54 illustratively includes a first pin 54A, a second pin 54B, a third pin 54C, and a fourth pin 54D. Though shown and described as including four pins 54, additional pins or fewer pins are contemplated. Each of the pins 54A, 54B, 54C, 54D extends outwardly away from the workpiece-receiving space 40, as shown in FIGS. 5 and 6. Each of the pins 54A, 54B, 54C, 54D extends outwardly from the third arm 38 of the body 28 beyond the surface of the third arm 38 that faces away from the workpiece-receiving space 40. Each pin 54 includes a pin body 55 and a groove 57 that extends into the pin body 55. Illustratively, the groove 57 extends entirely around a perimeter of the pin body 55. The groove 57 is spaced apart from a terminal end of the pin body 55.

Illustratively, each of the pins 54A, 54B, 54C, 54D is received in a corresponding hole formed in the body 28, as suggested in FIG. 4. Each of the pins 54A, 54B, 54C, 54D is received in the corresponding hole to extend outwardly beyond the surface of the third arm 38 beyond the second and third datums 52B, 52C. The pins 54A, 54B, 54C, 54D are located between the second datum 52B and the third datum 52C along the third arm 38. Each of the pins 54A, 54B, 54C, 54D extend parallel with each other.

In some embodiments, the body 28 may be formed to include a first pocket 56 and a second pocket 58, as shown in FIGS. 5 and 6. The pockets 56, 58 are illustratively formed as recesses in the third arm 38. The pockets 56, 58 are formed on opposing sides of the third arm 38. Depending on the type of the machine 14, the pockets 56, 58 may provide tool clearance. The pockets 56, 58 may also act as locating features for a portion of the machine 14, such as the flow block.

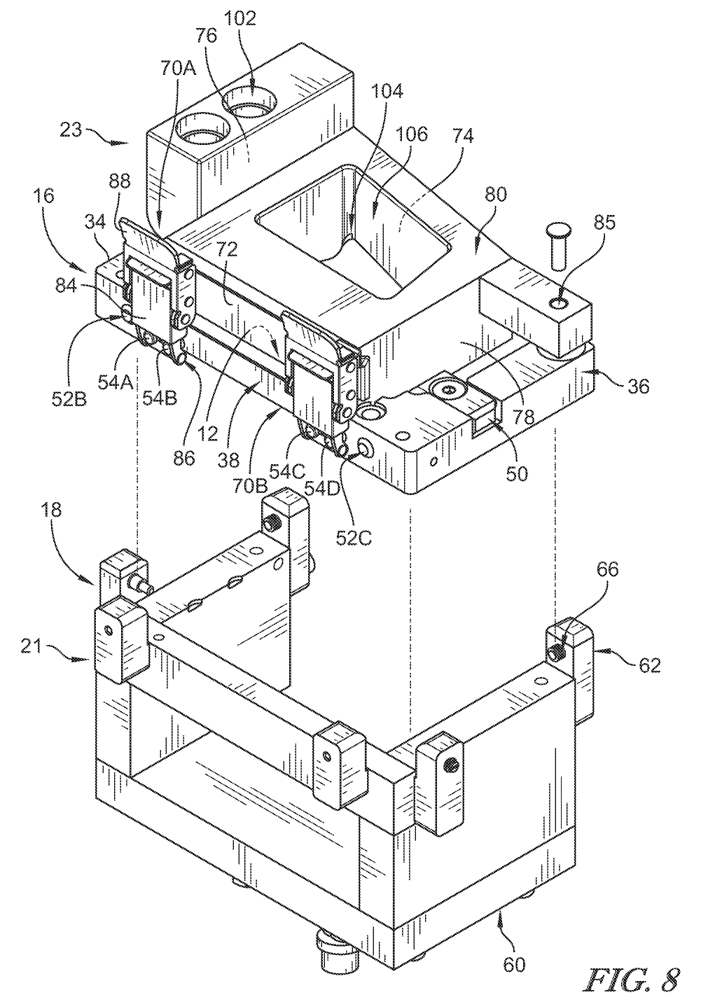

An exemplary base fixture 21 is shown in FIGS. 7 and 8. In some embodiments, the base fixture 21 is configured to be coupled with a frame of the machine 14. The base fixture 21 includes a foundation 60 and a plurality of locator blocks 62 extending from the foundation 60. Each of the plurality of locator blocks 62 includes a locator protrusion 66 extending outwardly therefrom toward the workpiece frame 16 to engage the corresponding secondary/tertiary frame locating datum 52. The plurality of locator blocks 62 allows the workpiece frame 16, and thus the workpiece 12, to be flipped 180 degrees between a first orientation and a second orientation such that both sides 22, 24 of the workpiece 12 may be modified. When using the exemplary base fixture 21, the workpiece 12 is substantially horizontal when coupled with the base fixture 21.

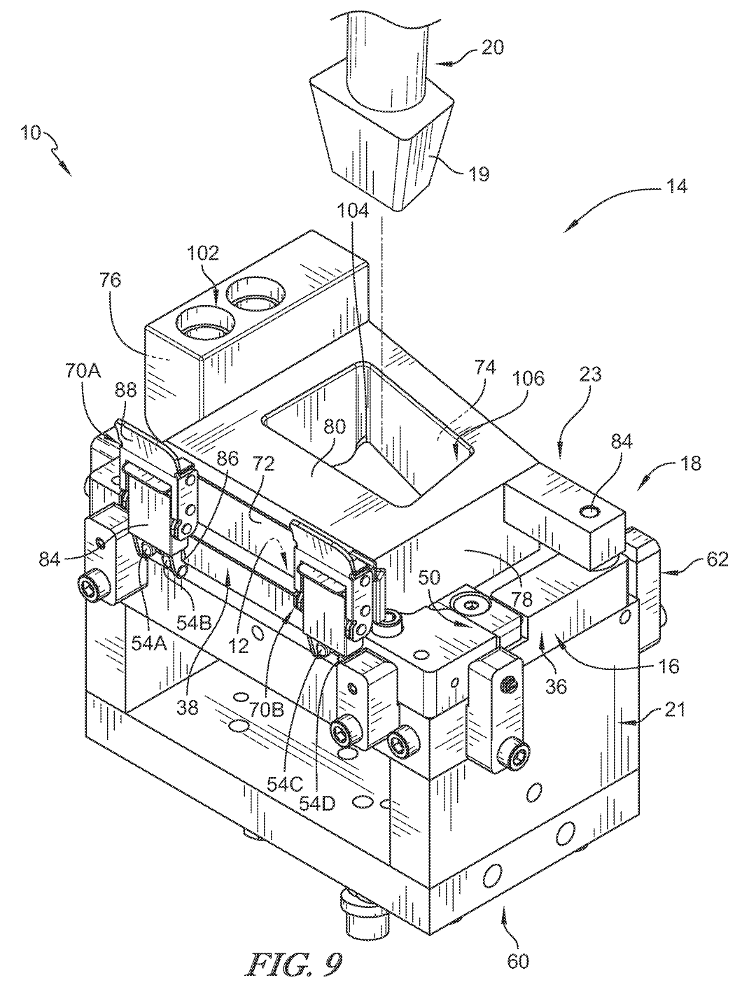

In an aspect of the present disclosure, strap clamp latch means are provided in the machine tool system 10 to removably couple the workpiece frame 16 with the tool 18 so that different faces of the workpiece 12 in the workpiece frame 16 can be machined without removing the workpiece 12 from the workpiece frame 16 as suggested in FIGS. 7-12 and 13-14. The latch means includes the cylindrical pins 54 which are formed with a registration/clamp groove 57. The pins 54 are positioned and pressed into holes perpendicular to one side surface of the workpiece frame 16. The pins 54 can be latched onto from two different latch clamp mechanisms 70 as suggested in FIGS. 8 and 9. One latch clamp 70A is spaced apart from the other clamp 70B (180 degrees) and each latch clamp 70 is mounted on a fixture of the tool 18 for an operation on the workpiece pECM fabrication assembly or any other machining station.

The fixture of the tool 18 may be the base fixture 21, the accessory fixture 23, the accessory fixture 223, or any other suitable fixture desired to be removably coupled with the workpiece frame 16. The workpiece 12 may be flipped 180 degrees over (relative to the plane that splits the pins central axes) to allow unique, but similar, pECM related apparatus to be clamped in position on the opposite side of the workpiece 12 and workpiece frame 16. For example, the workpiece frame 16 may be flipped over and used with the same accessory fixture 23, the accessory fixture 223 or other suitable fixture, the base fixture 21, or a base fixture 221.

In an illustrative embodiment, the tool 18 includes the base fixture 21, the accessory fixture 23, and the accessory fixture 223 as shown in FIGS. 7-12. The workpiece frame 16 is removably coupled with the base fixture 21 and the base fixture 21 is fixed with a frame of the machine 14 so that the workpiece frame 16 is held in a fixed position relative to the shaft 20 as discussed above. In some embodiments, the base fixture 21 is fixed to a moving portion of the machine 14 so that that workpiece frame 16 may be moved relative to the shaft during operation of the machine 14. The accessory fixture 23 couples with one or both of the workpiece frame 16 and the workpiece 12 to provide additional support, guides, fluid channels or other machining assistance. In the illustrative embodiment, the accessory fixture 23 directs the electrolytic fluid over the workpiece 12 during the machining operation and provides a guide for the shaft 20.

The accessory fixture 23 includes a fixture body 68 and at least one latch clamp 70 coupled with the fixture body 68 as shown in FIG. 7. In the illustrative embodiment, the at least one latch clamp 70 includes a first latch clamp 70A and a second latch clamp 70B. The latch clamps 70 are configured to selectively engage with the pins 54 of the workpiece frame 16 to urge the workpiece frame 16 toward the accessory fixture 23 and couple the workpiece frame 16 with the tool 18. The first latch clamp 70A is configured to engage the pins 54A, 54B and the second latch clamp 70B is configured to engage the pins 54C, 54D when the workpiece frame 16 is in the first orientation as suggested in FIGS. 7 and 8. If the same accessory fixture 23 is used when the workpiece frame 16 is flipped over, the first latch clamp 70A is configured to engage the pins 54C, 54D and the second latch clamp 70B is configured to engage the pins 54A, 54B.

The fixture body 68 includes a first side 72, a second side 74 opposite the first side 72, a third side 76, and a fourth side 78 opposite the third side 76, a top 80, and a bottom 82 opposite the top 80. The latch clamps 70 may be coupled to one or more of the sides, such as first side 72 as shown in FIG. 7. In the illustrative embodiment, the first latch clamp 70A is on the same side of the fixture body 68 as the second latch clamp 70B. In other embodiments, the first latch clamp 70A is on an opposite side of the fixture body 68 as the second latch clamp 70B or on a side perpendicular to the second latch clamp 70B.

Each latch clamp 70 includes a base mount 84, a latch 86, and a handle 88 as shown in FIG. 7. The base mount 84 is coupled with the fixture body 68. The latch 86 is pivotably coupled with the base mount 84 and configured to releasably engage one or more of the pins 54. The handle 88 is coupled with the base mount 84 and the latch 86 and configured to rotate about a handle axis to move the latch 86 and thereby open and close the latch 86. The base mount 84 may include one or more bias elements 90 for biasing the handle 88 and the latch 86 toward the open position. The handle 88 rotates less than 360 degrees to fully close the latch clamp 70 from the fully open position.

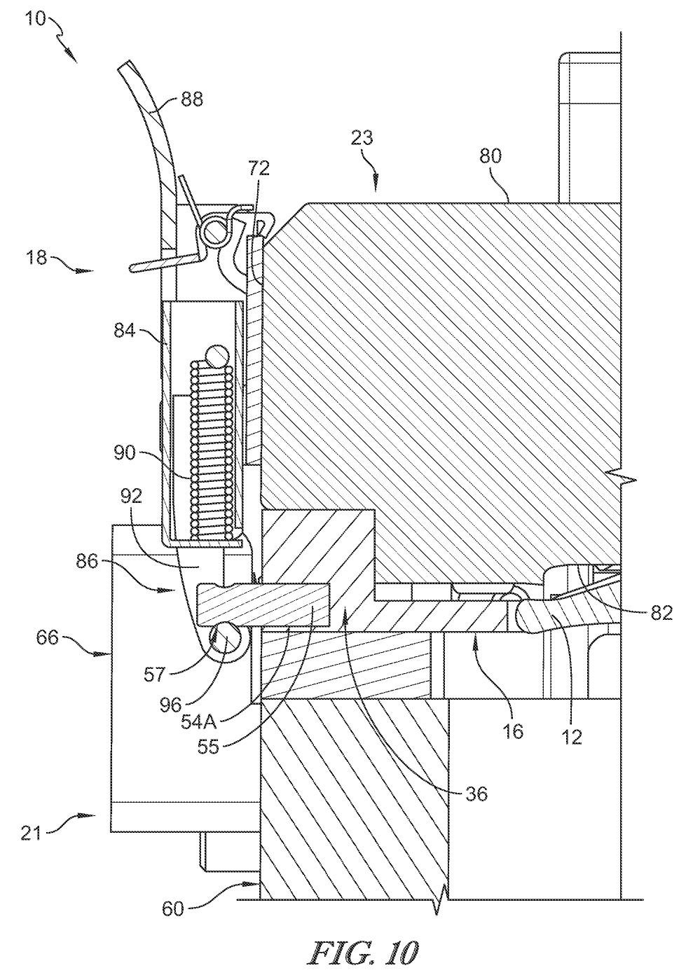

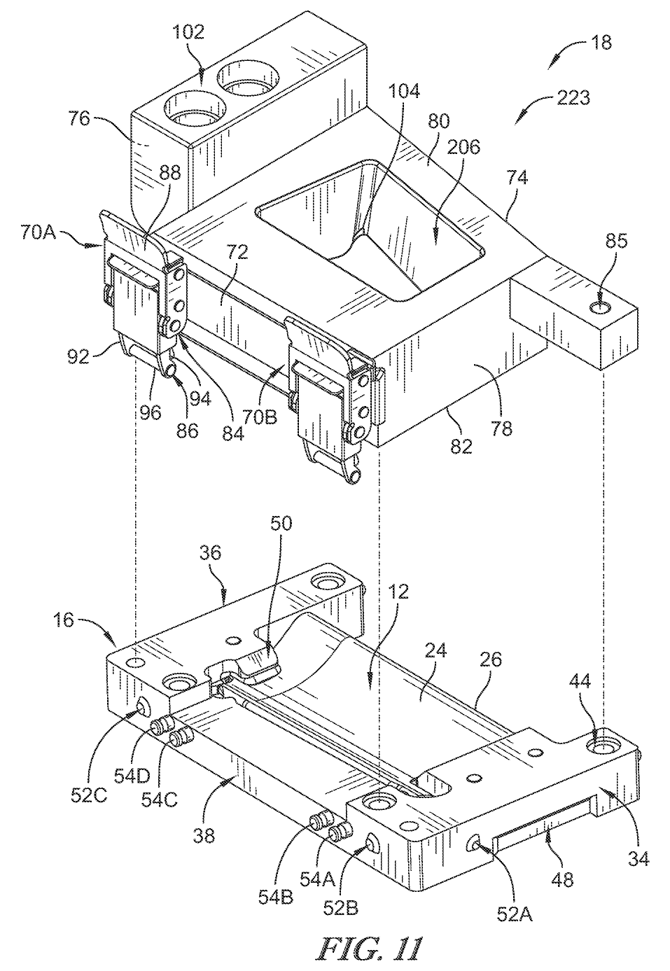

Each latch 86 includes a first arm 92, a second arm 94 spaced apart from the first arm 92, and a bar 96 that extends between the first arm 92 and the second arm 94 as shown in FIGS. 7-10. In the closed position of the latch 86, the bar 96 is received in the groove 57 formed in the pin 54 as shown in FIG. 10. In the closed position, the bar 96 applies a compressive force to the at least one pin 54 to cause the latch clamp 70 to urge the workpiece frame 16 toward the accessory fixture 23 thereby coupling the components together. Additional pins, or other fasteners may extend through holes 85 in the fixture body 68, through holes 44 in the workpiece frame 16, and into the base fixture 21 to further couple the components together and/or block relative movement of the components. In other embodiments, the latch 86 is formed as a claw, for example, made from a sheet of material.

In the illustrative embodiment of the accessory fixture 23, the fixture body 68 is formed to include a fluid inlet 102 and fluid passages 104 for directing the electrolytic fluid around and over the workpiece 12 during operation of the machine 14. The fixture body 68 is formed to define a guide passage 106 that extends entirely through the fixture body 68 to provide the shaft 20 of the machine 14 access to the surface of the workpiece 12 as suggested in FIG. 9. A machine tool bit 19, acting as the cathode, may be attached to the shaft 20 to provide the desired geometry of the surface of the workpiece 12 for the machining operation. The guide passage 106 is shaped to match the perimeter of the machine tool bit 19 in the illustrative embodiment to limit lateral movement of the machine tool bit 19 and to provide a seal for minimizing fluid flow between the bit 19 and the accessory fixture 23.

The accessory fixture 223 shown in FIGS. 11 and 12 is substantially similar to the accessory fixture 23. The accessory fixture 223 may be used to machine the second side 24 of the workpiece 12 as compared to using the accessory fixture 23. However, in some operations, the same accessory fixture 23 may be used when the workpiece frame 16 is flipped and the second side 24 is machined. The accessory fixture 223 includes a guide passage 206 shaped to work with a tool bit 219 to machine the second side 24 of the workpiece 12 such that the second side 24 is different than the first side 22. The passage 206 is shaped differently from the passage 106 and the tool bit 219 is shaped differently from the tool bit 19.

The accessory fixture 223 includes the fixture body 68 and the latch clamps 70 as shown in FIGS. 11 and 12. The first latch clamp 70A is configured to engage the pins 54C, 54D and the second latch clamp 70B is configured to engage the pins 54A, 54B of the workpiece frame 16 when the workpiece frame 16 is in the second orientation as suggested in FIGS. 11 and 12. The accessory fixture 223 may have structure different from accessory fixture 23 or, like the illustrative embodiment, may be substantially similar to the accessory fixture 23.

A method of using the machine tool system 14 may include any suitable combination of the following steps. The workpiece 12 is coupled with the workpiece frame 16. The workpiece 12 may be clamped and fixed with the workpiece frame 16 via the first clamp member 48 and the second clamp member 50 as suggested in FIGS. 4-6. The surface of the workpiece 12 desired to be machined is determined and the workpiece frame 16 is oriented relative to the accessory fixture 23 in the first orientation such that the desired surface is facing the shaft 20 of the machine 14.

The workpiece frame 16 is aligned with and moved relative to the accessory fixture 23 as suggested in FIG. 7. The first latch clamp 70A is in the open position and the latch 86 is moved around the first pin 54A and the second pin 54B. The handle 88 of the first latch clamp 70A is rotated to close the latch 86 and cause the bar 96 to engage the grooves 57 in the pins 54A, 54B to lock the workpiece frame 16 with the accessory fixture 23 as shown in FIG. 10. Optionally, if multiple latch clamps are included as shown in FIGS. 7-10, the second latch clamp 70B is in the open position and the latch 86 is moved around the third pin 54C and the fourth pin 54D. The handle 88 of the second latch clamp 70B is rotated to close the latch 86 and cause the bar 96 to engage the grooves 57 in the pins 54C, 54D to lock the workpiece frame 16 with the accessory fixture 23.

The workpiece frame 16 is attached to the base fixture 21. The workpiece frame 16 may be urged into engagement with the locator protrusions 66 of the locator blocks 62 to couple the workpiece frame 16 with the base fixture 21. The accessory fixture 23 may be coupled with the workpiece frame 16 before or after the workpiece frame 16 is inserted into the base fixture 21. Pins or other fasteners may be inserted through two or more of the workpiece frame 16, the base fixture 21, and the accessory fixture 23 to minimize movement between the components during the machining operation.

With the workpiece frame 16 coupled with the base fixture 21 and the accessory fixture 23, fluid is supplied through the inlet 102 of the accessory fixture 23 and the shaft 20 moves the tool bit 19 along the axis A back and forth relative to the workpiece 12 to remove material from the workpiece 12 as suggested in FIG. 9. In other embodiments, the tool bit 19 may contact the workpiece 12 to remove material therefrom such as in a drilling operation or may add material to the workpiece 12 via additive manufacturing.

Once the machining process is performed, the steps above are reversed to remove the workpiece frame 16 from the base fixture 21 and the accessory fixture 23. The workpiece 12 remains coupled with the workpiece frame 16 such that the datums are maintained for additional operations.

The workpiece frame 16 may be positioned in the second orientation and then the steps above repeated to couple the workpiece frame 16 to the accessory fixture 223 and the base fixture 21 as suggested in FIGS. 11 and 12, to the same accessory fixture 23, or to any other suitable fixture. In the illustrative embodiment, the workpiece frame 16 is rotated 180 degrees. The same or different machining operation may then be performed on another surface of the workpiece 12 with minimal set up time because the datums on the workpiece frame 16 were maintained. For example, the tool bit 19 may be changed for the tool bit 219 having another geometry shape for the PECM process and the machining operation used on the second surface of the workpiece 12. Illustratively, the workpiece frame 16 is coupled to the latches 70A, 70B of the accessory fixture 223 such that the second side 24 of the workpiece 12 faces the accessory fixture 223 as shown in FIGS. 11 and 12. The workpiece frame 16 is coupled with the base fixture 21. The tool bit 219 is attached to the shaft 20 and inserted into the guide passage 206 and the PECM process is performed to machine the second side 24 of the workpiece 12.

In some embodiments, the machine tool system 10 includes additional machines beyond the machine 14. For example, the machine tool system 10 may include the machine 14 capable of PECM and a second machine (not shown) capable of another type of machining. The PECM machine uses the substantially planar surfaces of the arms 34, 36, 38 as primary datums to help gain surface area for power transfer. The workpiece frame 16 is repositionable on the machine 14 and relocatable to the second machine. Thus, the workpiece 12 may be transferred to the second machine without requiring removal of the workpiece 12 from the workpiece frame 16. On the second machine, the workpiece frame 16 may be placed in different positions such that the workpiece 12 is positioned in different orientations. For example, the workpiece frame 16 may be positioned such that the body 28 opens to the right and the workpiece 12 is substantially vertical. As another example, the workpiece frame 16 may be positioned such that the body 28 opens to the left and the workpiece 12 is substantially vertical.

The second machine may be used for hole drilling via laser, cutting via laser, milling of surfaces, and/or cutting via electrical discharge machining (EDM). The second machine may also be used for inspection of the workpiece 12, for example, via non-contact three-dimensional scanning via blue light. The second machine may use different holes 44 than the machine 14 to couple the workpiece frame 16 to the base fixture 21.

In another illustrative embodiment, the tool 18 includes a base fixture 221 and the latch clamps 70 are coupled with the base fixture 221 as shown in FIGS. 13-14. The base fixture 221 may be substantially the same as the base fixture 21 and may include the foundation 60 and the plurality of locator blocks 62 extending from the foundation 60. Each of the plurality of locator blocks 62 may include a locator protrusion 66 extending outwardly therefrom toward the workpiece frame 16 to engage the corresponding frame locating datum 52. The latch clamps 70 are coupled with the foundation 60 and may be substantially similar to the latch clamps 70 described above.

The workpiece frame 16 is inserted into the base fixture 221 such that the locator protrusions 66 engage the datums 52 of the workpiece frame 16. The latch clamps 70 are closed to engage the pins 54A, 54B, 54C, 54D and couple the workpiece frame 16 with the base fixture 221. The accessory fixture 23, accessory fixture 223, or other fixture may be coupled with the workpiece frame 16, if desired, via fasteners or additional latch means and pins on the workpiece frame 16. The workpiece frame 16 is movable to couple with the base fixture 221 in a second orientation for additional machining processes. In the illustrative embodiment, the second orientation is 180 degrees rotated from the first orientation.

While the disclosure has been illustrated and described in detail in the foregoing drawings and description, the same is to be considered as exemplary and not restrictive in character, it being understood that only illustrative embodiments thereof have been shown and described and that all changes and modifications that come within the spirit of the disclosure are desired to be protected.

What is claimed is:

1. A machine tool system comprising:
a three-dimensional workpiece,
a machine configured to modify the three-dimensional workpiece, the machine including a tool configured to interface with the three-dimensional workpiece and a shaft spaced apart from the tool along a first axis and configured to move along the first axis relative to the tool to modify the three-dimensional workpiece, and
a workpiece frame that is repositionable and relocatable on the tool in at least two different orientations to support the three-dimensional workpiece in the at least two different orientations relative to the first axis during modification of the three-dimensional workpiece so that different sides of the three-dimensional workpiece are modified without requiring removal of the three-dimensional workpiece from the workpiece frame, the workpiece frame includes a body and a workpiece locator, the body defines a workpiece-receiving space therein and is removably coupled with the workpiece, and the workpiece locator includes a first pin coupled with and extending away from the body,
wherein the tool includes a fixture having a fixture body and a first latch clamp coupled with the fixture body and selectively engaged with the first pin of the workpiece frame to urge the workpiece frame toward the fixture and removably couple the workpiece frame with the tool.

2. The machine tool system of claim 1, wherein the fixture includes fluid passages formed therein and configured to direct a fluid onto the workpiece during operation of the machine and the workpiece frame is repositionable and relocatable on the fixture in the at least two different orientations.

3. The machine tool system of claim 2, wherein the tool further includes a base fixture coupled with a frame of the machine to locate the workpiece relative to the shaft and the workpiece frame is repositionable and relocatable on the base fixture in the at least two different orientations.

4. The machine tool system of claim 1, wherein the fixture is coupled with a frame of the machine to locate the workpiece relative to the shaft and the workpiece frame is repositionable and relocatable on the fixture in the at least two different orientations.

5. The machine tool system of claim 1, wherein the workpiece frame further includes a second pin spaced apart from the first pin and the first latch clamp is selectively engaged with the first pin and the second pin to couple the workpiece frame to the fixture.

6. The machine tool system of claim 1, wherein the workpiece frame further includes a second pin spaced apart from the first pin and the tool includes a second latch clamp that is selectively engaged with the second pin to couple the workpiece frame to the fixture.

7. The machine tool system of claim 6, wherein the second pin extends parallel to the first pin.

8. The machine tool system of claim 1, wherein the workpiece frame further includes a second pin that is spaced apart from the first pin and extends into the fixture to limit movement of the workpiece relative to the fixture.

9. The machine tool system of claim 8, wherein the first pin is formed with a groove that receives a portion of the latch clamp therein.

10. The machine tool system of claim 1, wherein the latch clamp includes a latch engaged with the first pin and a handle coupled with the latch and configured to rotate about a handle axis to open and close the latch, the latch including a first arm, a second arm spaced apart from the first arm, and a bar that extends between the first arm and the second arm, and the first pin is formed with a groove that receives a portion of the bar.

11. A machine tool system comprising:
a workpiece,
a machine configured to modify the workpiece, and
a workpiece frame that is repositionable and relocatable on the machine in at least two different orientations to support the workpiece in the at least two different orientations during modification of the workpiece so that different sides of the workpiece are modified without requiring removal of the workpiece from the workpiece frame, the workpiece frame includes a body and a workpiece locator, the body is removably coupled with the workpiece, and the workpiece locator includes a first pin coupled with and extending away from the body,
wherein the machine includes a tool for interfacing with the workpiece frame, the tool includes a fixture having a fixture body and a latch clamp coupled with the fixture body and selectively engaged with the first pin to removably couple the workpiece frame with the tool.

12. The machine tool system of claim 11, wherein the fixture is coupled with a frame of the machine and the workpiece frame is repositionable and relocatable on the fixture in the at least two different orientations without separating the workpiece from the workpiece frame.

13. The machine tool system of claim 11, wherein the fixture includes fluid passages formed therein and configured to direct a fluid onto the workpiece during operation of the machine and the workpiece frame is repositionable and relocatable on the fixture in the at least two different orientations without separating the workpiece from the workpiece frame.

14. The machine tool system of claim 11, wherein the workpiece frame further includes a second pin spaced apart from the first pin and the first latch clamp is selectively engaged with both the first pin and the second pin to couple the workpiece frame to the fixture.

15. The machine tool system of claim 11, wherein the first pin is formed with a groove that receives a portion of the latch clamp therein.

16. The machine tool system of claim 11, wherein the latch clamp includes a latch engaged with a groove of the first pin and a handle coupled with the latch and configured to rotate about a handle axis to open and close the latch.

17. The machine tool system of claim 17, wherein the latch includes a first arm, a second arm spaced apart from the first arm, and a bar that extends between the first arm and the second arm, and the first pin is formed with a groove that receives a portion of the bar.

18. The machine tool system of claim 17, wherein the handle rotates less than 360 degrees to move the latch clamp from a fully open position to a fully closed position.

19. A method of using a machine tool system, the method comprising:
coupling a workpiece to a workpiece frame;
positioning the workpiece frame relative to a first fixture such that the workpiece is in a first orientation;
latching the workpiece frame with the first fixture to couple the workpiece frame with the first fixture such that the workpiece is in the first orientation;
applying a first machine operation to the workpiece;
unlatching the workpiece frame from the first fixture;
positioning the workpiece frame relative to a second fixture such that the workpiece is in a second orientation without separating the workpiece from the workpiece frame;
latching the workpiece frame with the second fixture to couple the workpiece frame with the second fixture such that the workpiece is in the second orientation; and
applying a second machine operation to the workpiece.

20. The method of claim 19, wherein latching the workpiece frame with the first fixture to couple the workpiece frame with the first fixture such that the workpiece is in the first orientation includes closing a latch clamp around at least one pin coupled with a body of the workpiece frame.
